(19) United States
(12) Patent Application Publication
(10) Pub. No.: US 2020/0412923 A1
(43) Pub. Date: Dec. 31, 2020

(54) IMAGE-CAPTURING ASSEMBLY AND MANUFACTURING METHOD THEREOF

(71) Applicant: GUANGZHOU LUXVISIONS INNOVATION TECHNOLOGY LIMITED, Guangzhou (CN)

(72) Inventor: Po-Chih Hsu, Guangzhou (CN)

(73) Assignee: GUANGZHOU LUXVISIONS INNOVATION TECHNOLOGY LIMITED, Guangzhou (CN)

(21) Appl. No.: 17/015,805

(22) Filed: Sep. 9, 2020

(30) Foreign Application Priority Data
Mar. 27, 2020 (CN) 202010231764.7

(51) Int. Cl. H04N 5/225; G02B 7/04

(52) U.S. Cl. CPC H04N 5/2257; H04N 5/2254; H04M 1/0264; G02B 7/04; H04N 5/2253

(57) ABSTRACT

An image-capturing assembly and a manufacturing method for image-capturing element are provided. The image-capturing assembly includes an image-capturing element, an adhesive layer, and an optical sheet. The image-capturing element has an active area and a non-active area. The non-active area surrounds the active area. The adhesive layer includes a plurality of adhesive sublayers stacked sequentially. The adhesive layer is on the non-active area of the image-capturing element. The optical sheet is on the adhesive layer.

### CROSS-REFERENCE TO RELATED APPLICATION

This non-provisional application claims priority under 35 U.S.C. § 119(a) to Patent Application No. 202010231764.7 filed in China, P.R.C. on Mar. 27, 2020, the entire contents of which are hereby incorporated by reference.

### BACKGROUND

### Technical Field

This disclosure relates to an image-capturing assembly, in particular, to an image-capturing assembly applicable for portable electronic devices.

### Related Art

Along with the rapid developments of technologies, the specifications of portable electronic devices in various aspects improve in response to market demands. Nowadays market requirements for the portable electronic devices, such as the increase of resolution, the thickness of the device, and the size of the device, change the appearance of the electronic products.

Now, almost every person has his or her own mobile phone. Taking the mobile phone as an example, the mobile phones not only provide telecommunication functions as they did in the past, with the technology advancements, the mobile phones are also gradually developed to be equipped with various functions such as music playing, internet accessing, video playing, and photographing. In order to have these functions at the same time, the phone has to meet a specification of large-sized, high resolution, as well as thin and light.

### SUMMARY

However, it is understood that, usually, the larger the device is, the heavier the device is. Moreover, when the mobile phone is equipped with more functions, the number of the components assembled inside the mobile phone is more. As a result, the space inside the mobile phone is not enough. Furthermore, in order to ensure that the mobile phone has a receiving space big enough to receive the components inside the mobile phone, the surface of body of the mobile phone protrudes so that the mobile phone has more spaces for receiving different modules (e.g., the camera module).

In view of these, an image-capturing assembly is provided according to one or some embodiments of the instant disclosure.

In some embodiments, an image-capturing assembly comprises an image-capturing element, an adhesive layer, and an optical sheet. The image-capturing element has an active area and a non-active area. The non-active area surrounds the active area. The adhesive layer comprises a plurality of adhesive sublayers stacked sequentially. The adhesive layer is on the non-active area of the image-capturing element.

The optical sheet is on the adhesive layer.

In one or some embodiments, a number of the adhesive sublayers is at least three.

In one or some embodiments, an interface is between adjacent two adhesive sublayers of the adhesive sublayers.

In one or some embodiments, a height-to-width ratio (H/W) of the adhesive layer is not less than 0.5 and not greater than 3.

In one or some embodiments, a height of the adhesive layer is in a range between 50 micrometers and 200 micrometers, and a width of the adhesive layer is in a range between 70 micrometers and 200 micrometers.

In one or some embodiments, the adhesive layer is coated on the non-active area through inkjet.

In one or some embodiments, the adhesive layer is a continuous annular section, and a closed space is formed between the image-capturing element, the adhesive layer, and the optical sheet.

In one or some embodiments, the adhesive layer comprises a plurality of adhesive sections, the adhesive sections surround the active area.

In one or some embodiments, the image-capturing assembly further comprises a circuit board, a supporting member, and a focusing element. The circuit board is below the image-capturing element. The supporting member is at an outer side of the image-capturing element and on the circuit board. The focusing element is above the supporting member. The focusing element comprises an actuating element and a lens, and the lens is in the actuating element.

In one or some embodiments, a distance between a lower edge of the lens and an upper surface of the image-capturing element is in a range between 0.4 millimeters and 0.7 millimeters.

In one or some embodiments, the supporting member comprises a plurality of supporting sublayers stacked sequentially.

In one or some embodiments, the supporting member is coated on the circuit board at the outer side of the image-capturing element through inkjet.

In some embodiments, a manufacturing method for image-capturing assembly comprises forming a plurality of pre-cured layers on a non-active area of an image-capturing element; disposing an optical sheet on the pre-cured layers; and curing the pre-cured layers to form an image-capturing subassembly.

In one or some embodiments, a number of the pre-cured layers is at least three.

In one or some embodiments, the step of forming each of the pre-cured layers comprises: coating an adhesive glue layer on the non-active area; and pre-curing the adhesive glue layer to form the pre-cured layer.

In one or some embodiments, after the step of curing the pre-cured layers to form the image-capturing subassembly, the manufacturing method further comprises: fixing the image-capturing subassembly on a circuit board and electrically connecting the image-capturing subassembly to the circuit board; fixing a supporting member on the circuit board; and fixing a focusing element on the supporting member. The supporting member is at an outer side of the image-capturing subassembly. The focusing element comprises an actuating element and a lens, and the lens is in the actuating element.

In one or some embodiments, before the step of forming the pre-cured layers on the non-active area of the image-capturing element, the manufacturing method further comprises: fixing the image-capturing element on a circuit board.

In one or some embodiments, after the step of curing the pre-cured layers to form the image-capturing subassembly, the manufacturing method further comprises: electrically connecting the image-capturing subassembly to the circuit board; fixing a supporting member on the circuit board; and fixing a focusing element on the supporting member. The supporting member is at an outer side of the image-capturing subassembly. The focusing element comprises an actuating element and a lens, and the lens is in the actuating element.

In one or some embodiments, the image-capturing element is on a wafer, the wafer comprises a plurality of the image-capturing elements. The step of forming the pre-cured layers on the non-active area of the image-capturing element is forming the pre-cured layers on the non-active area of each of the image-capturing elements, respectively. The step of disposing the optical sheet on the pre-cured layers is disposing a plurality of the optical sheets on the pre-cured layers, respectively. The step of curing the pre-cured layers to form the image-capturing subassembly is curing the pre-cured layers to form a plurality of the image-capturing subassemblies, respectively.

In one or some embodiments, an interface is between adjacent two pre-cured layers of the pre-cured layers.

In one or some embodiments, the adhesive glue layer is coated on the non-active area through inkjet.

In one or some embodiments, a height-to-width ratio (H/W) of the pre-cured layers is not less than 0.5 and not greater than 3.

In one or some embodiments, a height of the pre-cured layers is in a range between 50 micrometers and 200 micrometers, and a width of the pre-cured layers is in a range between 70 micrometers and 200 micrometers.

In one or some embodiments, a distance between a lower edge of the lens and an upper surface of the image-capturing element is in a range between 0.4 millimeters and 0.7 millimeters.

Based on the image-capturing assembly according to one or some embodiments of the instant disclosure, the optical sheet and the image-capturing element is connected to each other through the adhesive layer, so that the distance between optical sheet and the image-capturing element can be reduced. Accordingly, in some embodiments, the overall height of the image-capturing assembly can be reduced to allow the portable electronic device to have a thin-and-light configuration. Moreover, in some embodiments, since the image-capturing element has the thin-and-light configuration, the body of the device does not necessarily need to be configured with the protruding structure so as to have an aesthetic appearance. Moreover, it is understood that, in the solution known to the inventor, the optical sheet is placed above the molding member at the outer side of the image-capturing element; conversely, according to one or some embodiments of the instant disclosure, the optical sheet is placed above the image-capturing element through the adhesive layer. Therefore, the problems occurring to the solution known to the inventor, that is, the optical sheet may be separated from the molding member, may be broken, or may fall off the molding member when the molding member is affected by an external force (e.g., impacted by the external force), can be prevented.

### BRIEF DESCRIPTION OF THE DRAWINGS

The disclosure will become more fully understood from the detailed description given herein below for illustration only, and thus not limitative of the disclosure, wherein:

FIG. 1A illustrates a top view of an image-capturing element of an image-capturing assembly according to some embodiments of the instant disclosure;

FIG. 1B illustrates a cross-sectional view of the image-capturing element of the image-capturing assembly along line 1B-1B shown in FIG. 1A;

FIG. 2A illustrates a top view of an image-capturing element and an adhesive layer of an image-capturing assembly according to some embodiments of the instant disclosure;

FIG. 2B illustrates a cross-sectional view of the image-capturing element and the adhesive layer of the image-capturing assembly along line 2B-2B shown in FIG. 2A;

FIG. 3A illustrates a top view of an image-capturing assembly according to some embodiments of the instant disclosure;

FIG. 3B illustrates a cross-sectional view of the image-capturing assembly along line 3B-3B shown in FIG. 3A;

FIG. 4 illustrates a top view of an image-capturing assembly having one adhesive section according to some embodiments of the instant disclosure;

FIG. 5 illustrates a top view of an image-capturing assembly having two adhesive sections according to some embodiments of the instant disclosure;

FIG. 6 illustrates a top view of an image-capturing assembly having two adhesive sections according some other embodiments of the instant disclosure;

FIG. 7 illustrates a top view of an image-capturing assembly having three adhesive sections according to some embodiments of the instant disclosure;

FIG. 8 illustrates a top view of an image-capturing assembly having three adhesive sections according some other embodiments of the instant disclosure;

FIG. 9 illustrates a top view of an image-capturing assembly having four adhesive sections according to some embodiments of the instant disclosure;

FIG. 10 illustrates a top view of an image-capturing assembly having four adhesive sections according some other embodiments of the instant disclosure;

FIG. 11A illustrates a cross-sectional view of an image-capturing assembly according to some embodiments of the instant disclosure;

FIG. 11B illustrates an enlarged partial view of the adhesive layer of the image-capturing assembly shown in FIG. 11A;

FIG. 12A illustrates a cross-sectional view of an image-capturing assembly according to some other embodiments of the instant disclosure;

FIG. 12B illustrates an enlarged partial view of the supporting member of the image-capturing assembly shown in FIG. 12A;

FIG. 13 illustrates a part of a photograph showing the adhesive layer of the image-capturing assembly according to some embodiments of the instant disclosure;

FIG. 14 illustrates a cross-sectional view of an image-capturing assembly with a common board for dual mode assembly according to some embodiments of the instant disclosure;

FIG. 15 illustrates a flowchart of a manufacturing method for image-capturing assembly according to some embodiments of the instant disclosure;

FIG. 16 illustrates a flowchart of the step S110 shown in FIG. 15;

FIG. 17 illustrates a flowchart of a manufacturing method for image-capturing assembly according some other embodiments of the instant disclosure;

FIG. 18 illustrates a flowchart of the step S220 shown in FIG. 17;

FIG. 19 illustrates a flowchart of a manufacturing method for image-capturing assembly according further some other embodiments of the instant disclosure; and

FIG. 20 illustrates a flowchart of the step S320 shown in FIG. 19.

### DETAILED DESCRIPTION

The image-capturing assembly 1 is applicable for portable electronic devices, and is utilized for capturing static or dynamic images. For instance, common mobile devices may be mobile phones, cameras, notebook computers, tablet computers, and the like.

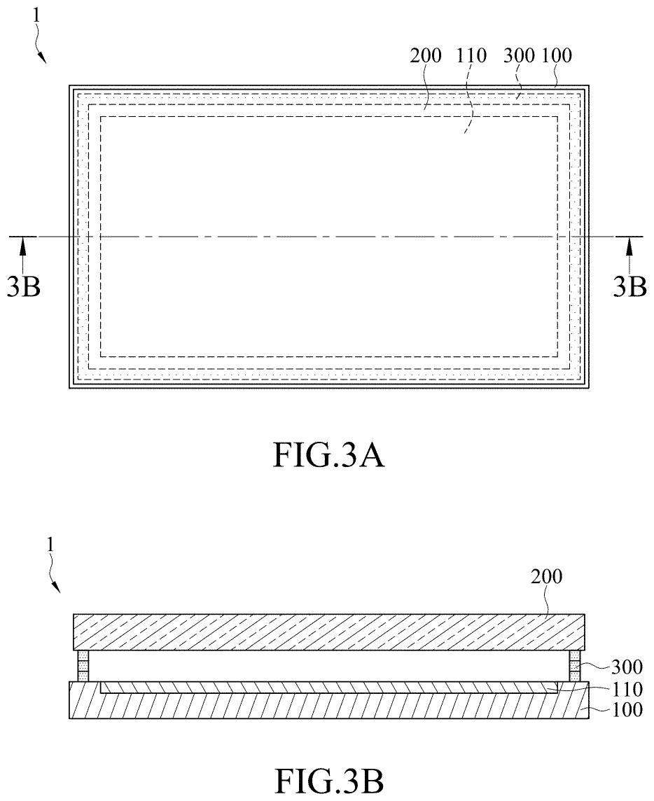

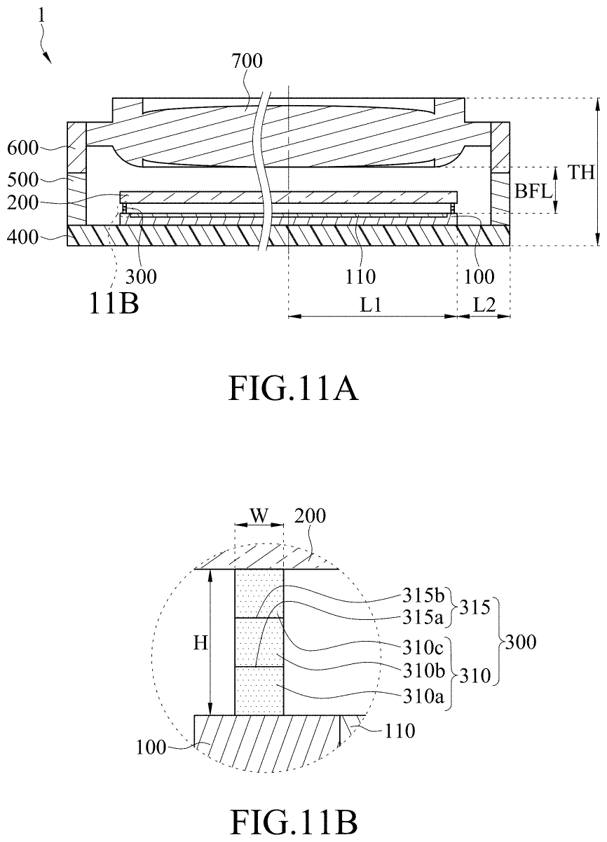

Please refer to FIGS. 3B, 11A, and 11B. In some embodiments, the image-capturing assembly 1 comprises an image-capturing element 100, an adhesive layer 300, and an optical sheet 200. The image-capturing element 100 has an active area 110 and a non-active area. The non-active area surrounds the active area 110. The adhesive layer 300 comprises a plurality of adhesive sublayers 310 stacked sequentially. In some embodiments, a number of the adhesive sublayers 310 is at least three. In this embodiment, the adhesive layer 300 comprises three adhesive sublayers 310 (the adhesive sublayer 310a, the adhesive sublayer 310b, and the adhesive sublayer 310c, respectively, as shown in FIG. 11B). The adhesive layer 300 is on the non-active area of the image-capturing element 100. The optical sheet 200 is on the adhesive layer 300.

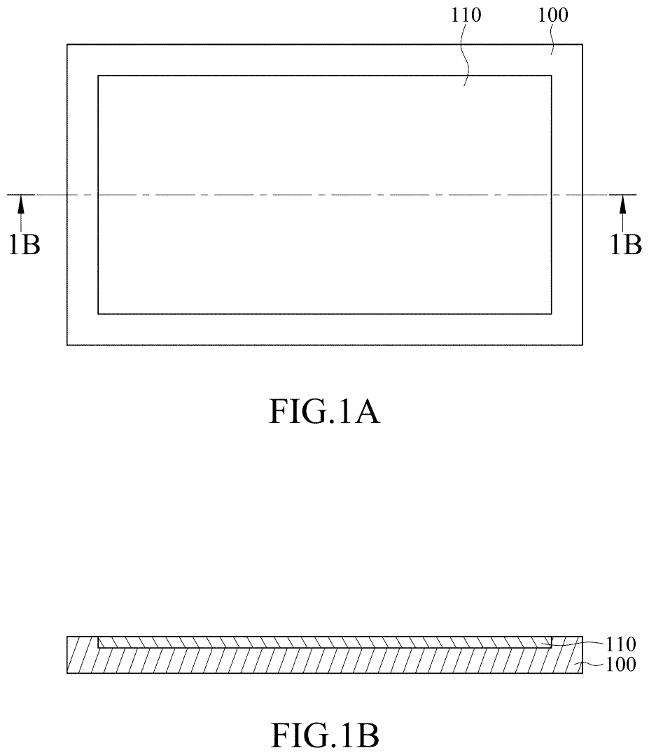

Please refer to FIGS. 1A and 1B. The image-capturing element 100 has an active area 110 and a non-active area, and the non-active area surrounds the active area 110. The active area 110 is an area for optical sensing, and the area out of the active area 110 is the non-active area (not labeled in the figures). The image-capturing element 100 is used to convert the optical image signal emitted to the image-capturing element 100 into an electrical image signal. The optical image signal is transmitted from outside of the mobile device, through the lens 700 and the optical sheet 200 (as shown in FIG. 11A), and then emitted to the active area 110 of the image-capturing element 100. For example, the image-capturing element 100 may be a complementary metal-oxide-semiconductor (CMOS) active pixel sensor or a charged coupled device (CCD).

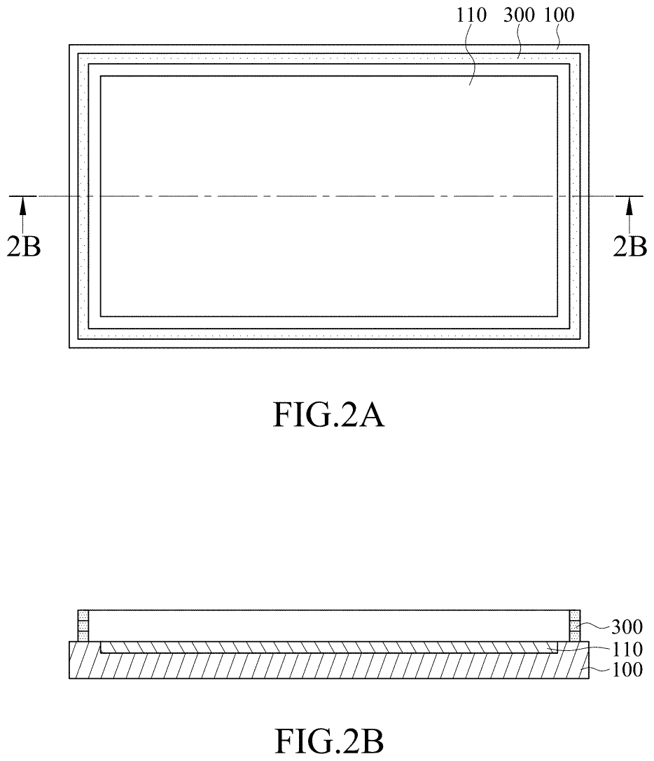

Please refer to FIGS. 2A and 2B. The adhesive layer 300 is on the non-active area of the image-capturing element 100. The adhesive layer 300 is used to provide supporting and fixing for element(s) adjacent to the adhesive layer 300. In some embodiments, the adhesive layer 300 can bear the pulling from adjacent element(s) and do not detach from the image-capturing element 100 in the life cycle of the adhesive layer 300. For example, the bonding strength of the adhesive layer 300 may be 500 grams, 1 kilogram to 2 kilograms. In some embodiments, the material of the adhesive layer 300 may be an adhesive glue. The adhesive glue has certain fluidity; however, the outer surface of the adhesive glue is pre-cured to lose the fluidity after the adhesive glue is treated by a pre-curing treatment; alternatively, the entire adhesive glue is cured to be a solid after the adhesive glue is treated by a curing treatment. Through the pre-curing or curing treatments, the adhesive glue can be prevented from crumbling due to the lack of fluidity after the adhesive glue is coated on the image-capturing element 100. Moreover, it is understood that, the adhesive glue is adhesive before and after the pre-curing treatment. For instance, the aforementioned “pre-curing treatment” may be achieved by emitting the UV light on the adhesive glue to achieve the pre-curing performance; conversely, the aforementioned “curing treatment” may be achieved by baking the adhesive glue with an oven to achieve the curing performance. In other words, in some embodiments, the adhesive glue (hereinafter, adhesive glue layer) is pre-cured to form the pre-cured layer, and the pre-cured layer is cured to form the adhesive layer 300. In some other embodiments, the adhesive glue layer is cured to form the adhesive layer 300. Moreover, in some embodiments, the adhesive layer 300 is acid-proof and anticorrosive.

In some embodiments, through the pre-curing and curing treatments, the adhesive layer 300 has a certain height-to-width ratio (H/W). The height-to-width ratio (H/W) is the ratio of the height H to the width W (as show in FIG. 11B). For instance, the height-to-width ratio (H/W) of the adhesive layer 300 may be not less than 0.5 and not greater than 3. In some examples, the height-to-width ratio (H/W) of the adhesive layer 300 may be 0.5, 1, 1.5, 2, 2.5, or 3. In an exemplary embodiment, the height H of the adhesive layer 300 is in a range between 50 and 200 micrometers (μm), and the width W of the adhesive layer 300 is in a range between 70 and 200 micrometers. For instance, in some examples, the height H of the adhesive layer 300 may be, 50 micrometers, 60 micrometers, 70 micrometers, 80 micrometers, 90 micrometers, 100 micrometers, 110 micrometers, 120 micrometers, 130 micrometers, 140 micrometers, 150 micrometers, 160 micrometers, 170 micrometers, 180 micrometers, 190 micrometers, or 200 micrometers. In some example, the width W of the adhesive layer 300 may be, 70 micrometers, 80 micrometers, 90 micrometers, 100 micrometers, 110 micrometers, 120 micrometers, 130 micrometers, 140 micrometers, 150 micrometers, 160 micrometers, 170 micrometers, 180 micrometers, 190 micrometers, or 200 micrometers. According to one or some embodiments of the instant disclosure, because of the aforementioned certain height-to-width ratios (H/W) of the adhesive layer 300, the occupied area of the adhesive layer 300 on the non-active area is smaller, thereby facilitating the size reduction of the entire assembly. Accordingly, the space of the mobile device occupied by the module can be reduced.

In some embodiments, the adhesive layer 300 is formed by a plurality of adhesive sublayers 310 (as shown in FIG. 11B, the adhesive layer 300 is formed by the adhesive sublayer 310a, the adhesive sublayer 310b, and the adhesive sublayer 310c). In some embodiments, a number of the adhesive sublayers is at least three. For instance, the number of the adhesive sublayers 310 is greater than or equal to three, or is greater than or equal to five. The adhesive glue layer coated on the non-active area is pre-cured to form the pre-cured layer. After the height of the stacked pre-cured layers meets the height needed by the adhesive layer 300, the pre-cured layers are cured to form the adhesive sublayers 310, and the adhesive sublayers 310 are referred to as the adhesive layer 300. In this embodiment, each of the pre-cured adhesive glue layers is referred to as the pre-cured layer, and each of the cured pre-cured layers is referred to as the adhesive sublayer 310. In some embodiments, the pre-cured layer has certain supportability. Hence, the pre-cured layer can bear the weight of the components stacked on the pre-cured layer before the curing treatment is performed to the pre-cured layer.

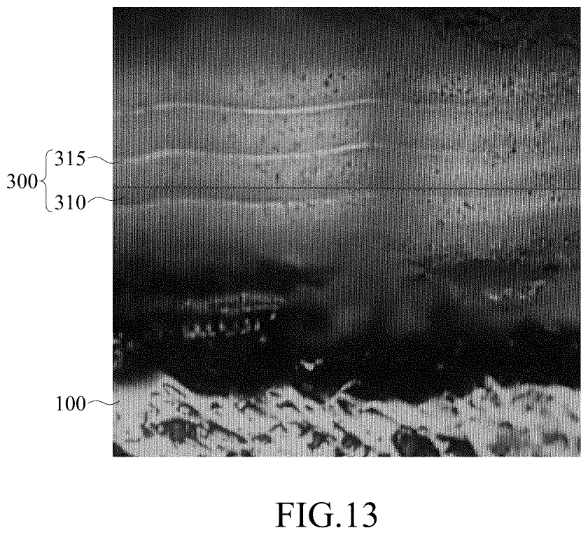

Please refer to FIGS. 11B and 13. In some embodiments, an interface 315 is between adjacent two adhesive sublayers 310. For instance, an interface 315a is between the adhesive sublayer 310a and the adhesive sublayer 310b (as shown in FIG. 11B). In some embodiments, after the adhesive glue layer is pre-cured (e.g., with the UV light treatment), the entire adhesive glue layer is slightly cured (not completely cured) to form the pre-cured layer. Next, another adhesive glue layer is coated on the pre-cured layer to perform another pre-cured treatment. In this embodiment, a clear boundary can be formed between the two pre-cured layers, and the boundary is referred to as the interface 315. As shown in FIG. 13, in one exemplary example, with the microscope photograph, a clear interface 315 between the two pre-cured layers can be seen. The foregoing steps are repeated until the height of the stacked pre-cured layers meets the height needed by the adhesive layer 300. After the height of the pre-cured layers meets the height needed by the adhesive layer 300, the pre-cured layers are cured to form the adhesive layer 300, and the adhesive layer 300 comprises the adhesive sublayers 310 and interfaces 315 between adjacent adhesive sublayers 310. In other words, in some embodiments, the adhesive glue layers may be coated on the non-active area sequentially, and the adhesive glue layers are pre-cured sequentially to form a plurality of pre-cured layers, until the height of the stacked pre-cured layers meets the height needed by the adhesive layer 300. In some embodiments, after the last layer of the adhesive glue layers is pre-cured to form the pre-cured layer, the optical sheet 200 is placed on the last layer of the pre-cured layers. Moreover, in some embodiments, the interface 315 between the two pre-cured layers or between the two adhesive sublayers 310 may be substantially even or uneven.

In an exemplary example, first, a first layer of the adhesive glue layers is coated on the non-active area, and then the first layer of the adhesive glue layers is pre-cured to form a first pre-cured layer. Next, a second layer of the adhesive glue layers is coated on the upper surface of the first pre-cured layer, and then the second layer of the adhesive glue layers is pre-cured to form a second pre-cured layer. Now, an interface 315a is formed between the first pre-cured layer and the second pre-cured layer. Next, rest of the adhesive glue layers are sequentially coated on the pre-cured layers, and after each of the adhesive glue layers is coated on the pre-cured layers, the pre-cured treatments are performed sequentially. In this embodiment, an interface 315a is formed between the first pre-cured layer and the second pre-cured layer, and an interface 315b is formed between the second pre-cured layer and the third pre-cured layer. The foregoing steps are repeated until the height of the stacked pre-cured layers meets the height needed by the adhesive layer 300. Next, after the optical sheet 200 is placed on the last layer of the pre-cured layers, the image-capturing element 100, the pre-cured layers, and the optical sheet 200 are pre-cured, so that the pre-cured layers form the adhesive layer 300. In this embodiment, the pre-cured layers are cured to form stacked adhesive sublayers 310 (namely, the adhesive sublayers 310a, the adhesive sublayers 310b, the adhesive sublayers 310c, etc.), and a plurality of interfaces 315 (namely, the interface 315a, the interface 315b, etc.) is between the stacked adhesive sublayers 310. Moreover, the adhesive sublayers 310 between the image-capturing element 100 and the optical sheet 200 are the adhesive layer 300. Furthermore, the pre-cured layers with the pre-cured treatment have certain adhesiveness, so that the pre-cured layers can fix components adjacent thereto.

Because the adhesive layer 300 can be disposed on the non-active area without moldings, the development period for the product is shorter. In some embodiments, the adhesive layer 300 is coated on the non-active area through inkjet. In other words, each of the adhesive sublayers 310 is coated on the non-active area through inkjet. For example, after each of the adhesive glue layers is coated on the non-active area through inkjet and pre-cured, the pre-cured layers are cured to form the adhesive layer 300.

Please refer to FIGS. 3A and 3B. The optical sheet 200 is on the adhesive layer 300. In some embodiments, the optical sheet 200 may be an optical filter for filtering the optical image signal emitted from the lens 700. In some embodiments, the optical sheet 200 is used to allow visible lights to transmit therethrough and to block invisible lights. For example, the wavelength range of the aforementioned visible lights is generally 400-700 nanometers (nm), indicating that light having a wavelength of 400-700 nm can pass through the optical sheet 200 and light having a wavelength not in the range of 400-700 nm will be blocked by the optical sheet 200. In some other embodiments, the optical sheet 200 can allow visible lights and some infrared rays to pass therethrough. In some further embodiments, the optical sheet 200 allows only infrared rays to pass therethrough. Moreover, in some embodiments, the material of the optical sheet 200 may be glass or plastic. In some other embodiments, the optical sheet 200 may be devoid of the light filtering function; for example, the optical sheet 200 may be a transparent glass sheet or a transparent plastic sheet, and the optical sheet 200 is disposed on the adhesive layer 300 for dustproof function or for protecting the active area 110 of the image-capturing element 100.

Moreover, the optical sheet 200 is disposed on the adhesive layer 300 corresponding to the image-capturing element 100. More specifically, in some embodiments, the optical sheet 200 is disposed at least corresponding to the active area 110 of the image-capturing element 100. Furthermore, in some embodiments, the material of the adhesive glue layers for forming the adhesive sublayers 310 may have a color being opaque. Therefore, the light leakage at edges of the image-capturing assembly 1 can be effectively reduced.

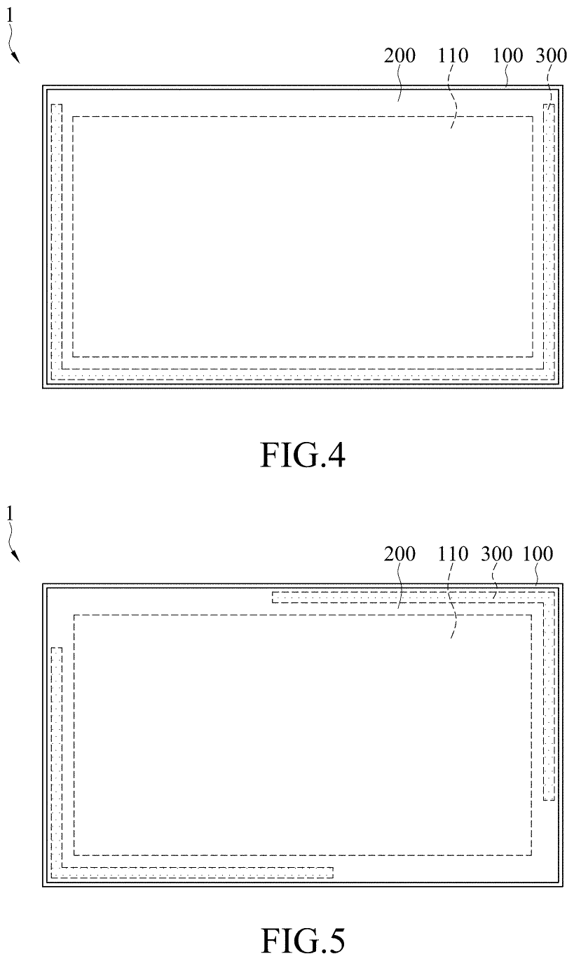

Please refer to FIG. 3A as well as FIGS. 4 to 10. The adhesive layer 300 may be one adhesive section or a plurality of adhesive sections. In some embodiments, in the case that the adhesive layer 300 is one adhesive section, the adhesive section may be disposed on the non-active area continuously or discontinuously. Please refer to FIG. 3A, in some embodiments, the adhesive layer 300 is a continuous annular adhesive section, and a closed space is formed between the image-capturing element 100, the adhesive layer 300, and the optical sheet 200. In other words, in this embodiment, the adhesive section is continuously disposed on the image-capturing element 100 and the adhesive section annularly surrounds the non-active area at the outer side of the active area 110, and the adhesive section 300, the image-capturing element 100, and the optical sheet 200 form the closed space. Accordingly, particles in the air can be prevented from entering into the space between the image-capturing element 100 and the optical sheet 200; moreover, during washing the image-capturing assembly 1 on the production line, liquid can be prevented from flowing into the active area 110. Please refer to FIG. 4, in some embodiments, the adhesive layer 300 is an adhesive section discontinuously disposed on the image-capturing element 100, and the adhesive section is not annular. In the case that the adhesive layer 300 is one adhesive section, the adhesive section should be formed on at least three sides of the non-active area, so that the optical sheet 200 can be placed above the image-capturing element 100 flatly and stably.

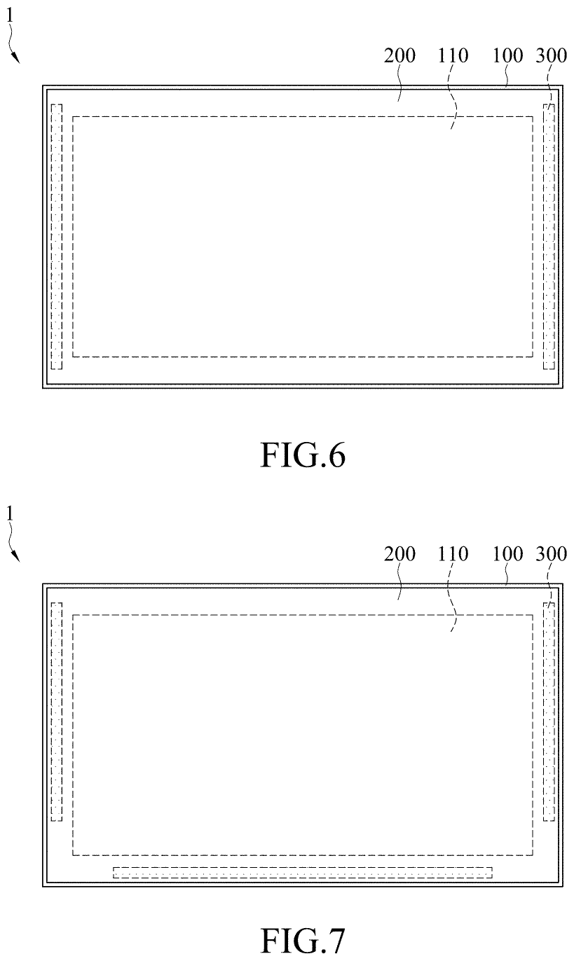

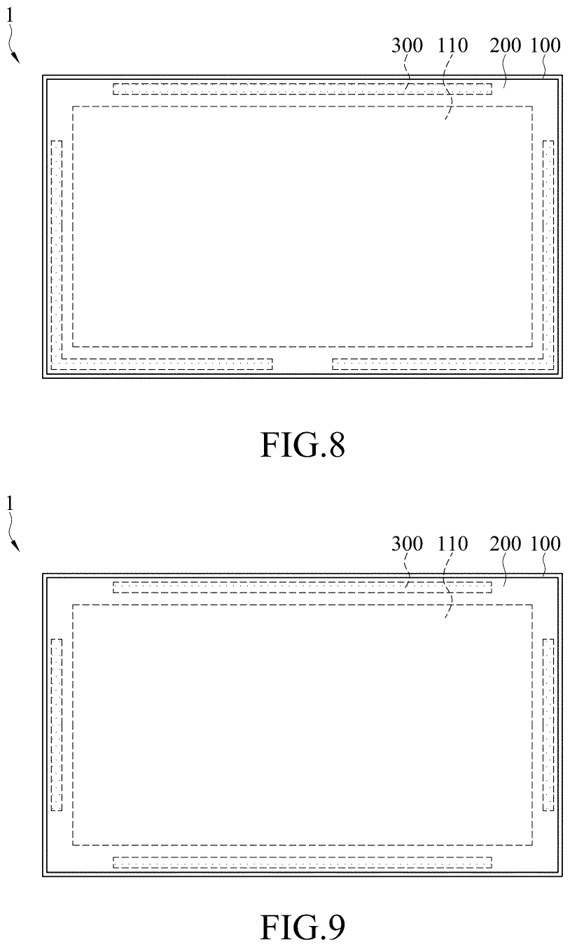

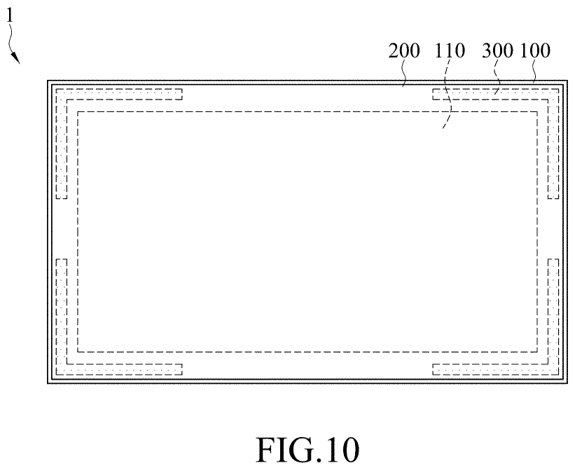

In some embodiments, the adhesive layer 300 comprises a plurality of adhesive sections, and the adhesive sections surround the active area 110. For example, the adhesive layer 300 may be, but not limited to, two, three, four, or more adhesive sections. Moreover, each of the adhesive sublayers 310 of the adhesive layer 300 comprises a plurality of adhesive subsections, and the number of the adhesive subsections of each of the adhesive sublayers 310 equals to the number of the adhesive sections. For example, in the case that the adhesive layer 300 is two adhesive sections, each of the adhesive sublayers 310 of the adhesive layer 300 comprises two adhesive subsections as well. Please refer to FIGS. 5 and 6, in some embodiments, the adhesive layer 300 is two adhesive sections, and the two adhesive sections are disposed on the image-capturing element 100 corresponding to each other, so that the optical sheet 200 can be disposed above the image-capturing element 100 flatly and stably. In some embodiments, the lengths of the two adhesive sections may be equal or unequal. In some embodiments, the two adhesive sections may be disposed on portions of the non-active area at the lateral sides out of the active area 110 (as shown in FIG. 6); alternatively, the two adhesive sections may be disposed on portions of the non-active area at any two opposite corners out of the active area 110 (as shown in FIG. 5). Please refer to FIGS. 7 and 8, in some embodiments, the adhesive layer 300 is three adhesive sections, and the lengths of the adhesive sections may be equal or unequal. The three adhesive sections are respectively disposed on portions of the non-active area where are on at least three sides out of the active area 110, so that the optical sheet 200 can be disposed above the image-capturing element 100 flatly and stably. For example, the three adhesive sections may be disposed on portions of the non-active area at three sides out of the active area 110 (as shown in FIG. 7); alternatively, the three adhesive sections may be disposed on portions of the non-active area at two corners and one sides out of the active area 110 (as shown in FIG. 8). Please refer to FIGS. 9 and 10, in some embodiments, the adhesive layer 300 is four adhesive sections, and the lengths of the four adhesive sections may be equal or unequal. The four adhesive sections are respectively disposed on portions of the non-active area where are on at least three sides out of the active area 110, so that the optical sheet 200 can be disposed above the image-capturing element 100 flatly and stably. For example, the four adhesive sections may be disposed on portions of the non-active area at four sides out of the active area 110 (as shown in FIG. 9); alternatively, the four adhesive sections may be disposed on portion of the non-active area at four corners out of the active area 110 (as shown in FIG. 10).

Please refer to FIG. 11A, in some embodiments, the image-capturing assembly 1 further comprises a circuit board 400, a supporting member 500, and a focusing element. The circuit board 400 is below the image-capturing element 100. The supporting member 500 is at an outer side of the image-capturing element 100 and the supporting member 500 is on the circuit board 400. The focusing element is above the supporting member 500. The focusing element comprises an actuating element 600 and a lens 700, and the lens 700 is in the actuating element 600. In some embodiments, the actuating element 600 may be a voice coil motor (VCM) or a stepper motor.

The circuit board 400 may be, but not limited to, a printed circuit board (PCB), a flexible printed circuit board (flexible PCB), or a rigid flexible printed circuit board (RFPC).

The lens 700 is used for adjusting the light beams (namely, in this embodiment, the optical image signal) entering into the lens 700 from outside of the mobile device, and the lens 700 is used for guiding the optical image signal to be transmitted toward the optical sheet 200 and the image-capturing element 100. When the actuating element 600 is actuated, the lens 700 in the actuating element 600 can be moved upwardly and downwardly, thereby changing the distance between the lens 700 and the image-capturing element 100. Hence, the image-capturing assembly 1 is capable of performing the focusing function. Moreover, in some embodiments, the focusing element has a fixed focus (FF) module or an automatic focus (AF) module.

Please refer to FIG. 11A. A distance is between the lower edge of the lens 700 and an upper surface of the image-capturing element 100, and the distance is the back focal length (BFL). The back focal length (BFL) is measured when the lens 700 is focused at infinity. In some embodiments, the distance between the lower edge of the lens 700 and the upper surface of the image-capturing element 100 is in a range between 0.4 millimeters and 0.7 millimeters. In other words, the back focal length (BFL) of the image-capturing assembly 1 may be in a range between 0.4 millimeters and 0.7 millimeters. In some embodiments, the back focal length (BFL) of the image-capturing assembly 1 may be, for example, 0.4 millimeters, 0.45 millimeters, 0.5 millimeters, 0.55 millimeters, 0.6 millimeters, 0.65 millimeters, or 0.7 millimeters.

According to the usage demands for different mobile devices, the image-capturing assembly 1 of the mobile device may have different back focal lengths (BFL). Moreover, when the back focal length (BFL) is reduced, the total height TH of the image-capturing assembly 1 can be reduced. Taking the image-capturing assembly 1 as the camera lens for a mobile phone as an example, in some embodiments, when the image-capturing assembly 1 utilizes the fixed focus module, the back focal length (BFL) of the fixed focus module is 0.46 mm. In some other embodiments, when the image-capturing assembly 1 utilizes the automatic focus module, the back focal length (BFL) of the automatic focus module is 0.51 mm.

In some exemplary examples, two image-capturing assemblies 1 with different structures are compared with each other. In a reference group, the image-capturing assembly 1 has a protrusion formed at the side portion of the supporting member 500 which is adjacent to the image-capturing element 100, and the protrusion is used for disposing the optical sheet 200 above the image-capturing element 100. Conversely, in an experiment group, the image-capturing assembly 1 has the optical sheet 200 disposed above the image-capturing element 100 through the adhesive sheet 300 (as shown in FIG. 11A). The back focal length (BFL) of the reference group includes the thickness of the protrusion of the supporting member 500, and the back focal length (BFL) of the fixed focus module and the back focal length (BFL) of the automatic focus module for the reference group are both 0.7 mm. On the other hand, in the experiment group, since the optical sheet 200 is disposed above the image-capturing element 100 through the adhesive layer 300, the height of the adhesive layer 300 is the distance between the optical sheet 200 and the image-capturing element 100. In other words, the back focal length (BFL) of the experiment group excludes the thickness of the protrusion of the supporting member 500, and the back focal length (BFL) of the fixed focus module and the back focal length (BFL) of the automatic focus module for the experiment group are 0.46 mm and 0.51 mm, respectively. It is understood that, because the back focal lengths (BFL) of the image-capturing assembly 1 in the experiment group are both shorter than the back focal lengths (BFL) of the image-capturing assembly 1 in the reference group. The total height TH of the image-capturing assembly 1 of the experiment group can be reduced by at least 0.2 mm.

Moreover, in FIG. 11A, the distance between a center portion of the image-capturing element 100 and the edge of the image-capturing element 100 is L1, and the distance between the edge of the image-capturing element 100 and the edge of the image-capturing assembly 1 is L2. In an example, the distances L1 and L2 between the experiment group and the reference group are compared with each other. Firstly, since the sizes of the center portions of the image-capturing elements 100 for the experiment group and the reference group are the same, the distance L1 of the experiment group is the same as the distance L1 of the reference group. Moreover, since the supporting member 500 of the reference group further has the protrusion, the L2 includes the length of the protrusion. Therefore, the distance L2 of the reference group is greater than the distance L2 of the experiment group. In other words, when the optical sheet 200 is disposed above the image-capturing element 100 through the adhesive layer 300, the distance L2 of the image-capturing assembly 1 is narrower.

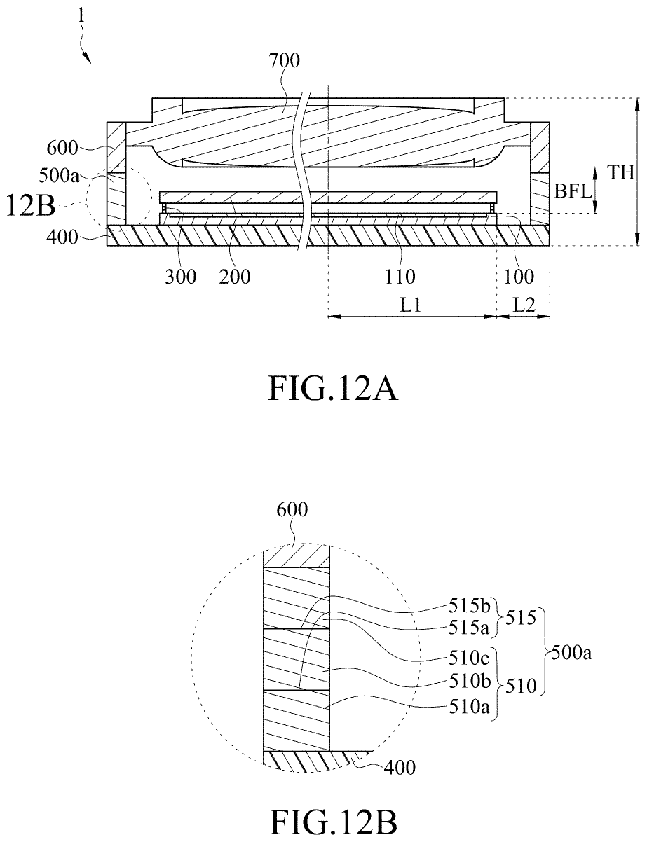

Please refer to FIGS. 11A and 12A. The supporting member 500 is on the circuit board 400 and is on the outer side of the image-capturing element 100. In some embodiments, the number of the supporting member 500 may be adjusted according to practical requirements; in other words, the number of the supporting member 500 may be one or plural. The supporting member 500 may be a glue material integrally formed by injection molding, or may be a plurality of supporting sublayers 510 stacked sequentially (as shown in FIG. 12B) formed by inkjet (e.g., 3D printing). In other words, in some embodiments, the material of the supporting member 500 may be the same as the material of the adhesive layer 300; namely, the material of the supporting member 500 is the adhesive glue, and the characteristics of the adhesive glue are provided as above and are omitted here. Please refer to FIGS. 12A and 12B, in some embodiments, the supporting member 500a comprises a plurality of supporting sublayers 510 (e.g., the supporting sublayer 510a, the supporting sublayer 510b, and the supporting sublayer 510c) stacked sequentially. For example, the number of the supporting sublayers 510 is greater than or equal to three. In some embodiments, an interface 515 is between adjacent two supporting sublayers. For example, an interface 515a is between the supporting sublayer 51a and the supporting sublayer 510b, as shown in FIG. 12B. In some embodiments, the supporting member 500a is coated on the circuit board 400 at the outer side of the image-capturing element 100 through inkjet. In other words, each of the supporting sublayers 510 is coated on the circuit board 400 at the outer side of the image-capturing element 100 through inkjet. For example, the formation of the supporting member 500 may be the same as the formation of the adhesive layer 300, and the description thereof is omitted here.

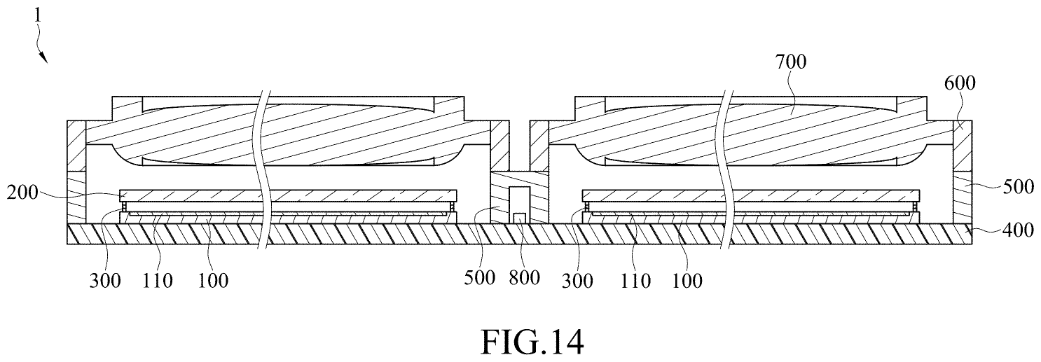

Please refer to FIG. 14, according to one or some embodiments of the instant disclosure, the optical sheet 200 does not need to be supported above the image-capturing element 100 through the supporting member 500 or other supporting parts, and the configuration of the optical sheet 200 does not affect the configuration of the supporting member 500. Hence, in some embodiments, the image-capturing assembly 1 is configured as a common board for dual mode assembly. In other words, in these embodiments, the image-capturing assembly 1 comprises one circuit board 400, two image-capturing elements 100 each having an active area 110, at least two adhesive layers 300, two optical sheets 200, one supporting member 500, and two focusing elements. The two image-capturing elements 100 are disposed on the same circuit board 400. The two optical sheets 200 are disposed on the respective image-capturing elements 100 through the adhesive layers 300. The two focusing elements are disposed above the supporting member 500. In some embodiments, one supporting member 500 is between the two image-capturing elements 100, and the two focusing elements may share the supporting member 500. Moreover, in some embodiments, the supporting member 500 may comprise a receiving space for receiving an electronic component 800 on the circuit board 400, as shown in FIG. 14.

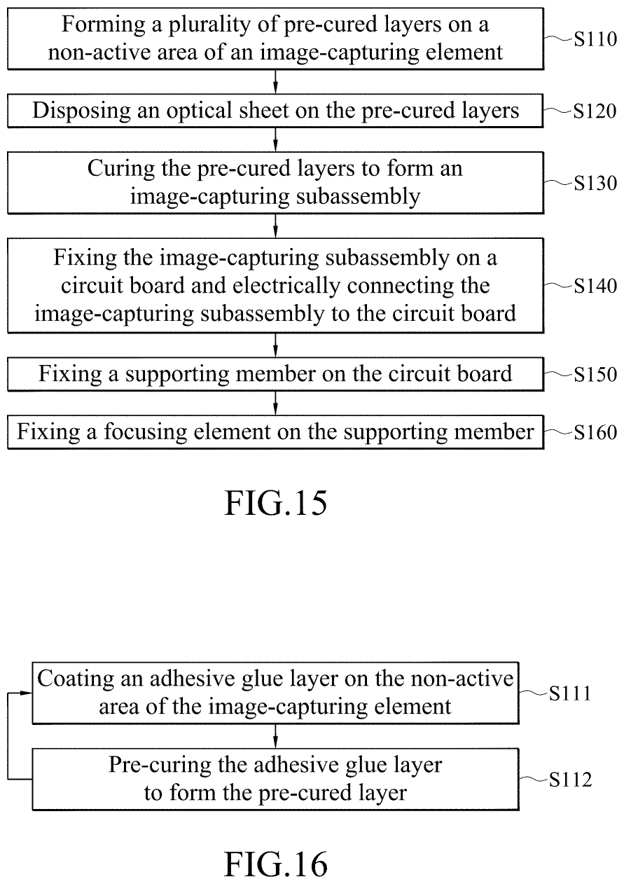

Please refer to FIGS. 15 and 16. In some embodiments, the manufacturing method of the image-capturing assembly 1 comprises forming a plurality of pre-cured layers on a non-active area of an image-capturing element 100, disposing an optical sheet 200 on the pre-cured layers, and curing the pre-cured layers to form an image-capturing subassembly. In some embodiments, a number of the pre-cured layers is at least three. In some embodiments, the step of forming each of the pre-cured layers comprises: coating an adhesive glue layer on the non-active area, and pre-curing the adhesive glue layer to form the pre-cured layer.

Please refer to FIG. 15, in some embodiments, firstly, an image-capturing element 100 (as shown in FIGS. 1A and 1B) is provided. Then, a plurality of pre-cured layers is formed on the non-active area of the image-capturing element 100 (namely, the step S110). In this embodiment, three pre-cured layers are formed on the non-active area of the image-capturing element 100 (as shown in FIGS. 2A and 2B). Please refer to FIG. 16, in one exemplary example of the step S110, the step of forming each of the pre-cured layers comprises coating an adhesive glue layer on the non-active area of the image-capturing element 100 (namely, the step S111) and pre-curing the adhesive glue layer to form the pre-cured layer (namely, the step S112). In some embodiments, the adhesive glue layer is coated on the non-active area through inkjet. In some embodiments, the adhesive glue layer is treated by the pre-curing treatment to form the pre-cured layer; a clear boundary can be formed between adjacent two pre-cured layers, and the boundary is referred to as the interface 315. In some embodiments, the pre-cured layer is adhesive and capable of supporting components thereon. In some embodiments, the height-to-width ratio (H/W) of the pre-cured layers may be not less than 0.5 and not greater than 3. In some examples, the height-to-width ratio (H/W) of the pre-cured layers may be 0.5, 1, 1.5, 2, 2.5, or 3. In an exemplary embodiment, the height of the pre-cured layers is in a range between 50 and 200 micrometers (μm), and the width of the pre-cured layers is in a range between 70 and 200 micrometers. For instance, in some examples, the height of the pre-cured layers may be, 50 micrometers, 60 micrometers, 70 micrometers, 80 micrometers, 90 micrometers, 100 micrometers, 110 micrometers, 120 micrometers, 130 micrometers, 140 micrometers, 150 micrometers, 160 micrometers, 170 micrometers, 180 micrometers, 190 micrometers, or 200 micrometers. In some example, the width of the pre-cured layers may be, 70 micrometers, 80 micrometers, 90 micrometers, 100 micrometers, 110 micrometers, 120 micrometers, 130 micrometers, 140 micrometers, 150 micrometers, 160 micrometers, 170 micrometers, 180 micrometers, 190 micrometers, or 200 micrometers.

After the step S110, in some embodiments, an optical sheet 200 is disposed on the pre-cured layers (namely, the step S120, as shown in FIGS. 3A and 3B). Since the pre-cured layer is adhesive, the optical sheet 200 can be fixed on the pre-cured layer, and the pre-cured layer is sufficient for supporting the optical sheet 200. Next, in some embodiments, the pre-cured layers are cured to form an image-capturing subassembly (namely, the step S130). In other words, in some embodiments, the image-capturing subassembly comprises the image-capturing element 100, the optical sheet 200, and the pre-cured layers. In an exemplary example of the step S130, the optical sheet 200, the pre-cured layers, and the image-capturing element 100 are cured with an oven. In this embodiment, the pre-cured layers after the curing treatment are the adhesive layers 300 shown in FIGS. 3A and 3B.

After the step S130, in some embodiments, after the step of curing the pre-cured layers to form the image-capturing subassembly (namely, the step S130), the manufacturing method further comprises fixing the image-capturing subassembly on a circuit board 400 and electrically connecting the image-capturing subassembly to the circuit board 400 (namely, the step S140), fixing a supporting member 500 (or a supporting member 500a) on the circuit board 400 (namely, the step S150), and fixing a focusing element on the supporting member 500 (or the supporting member 500a) (namely, the step S160). The supporting member 500 (or the supporting member 500a) is at the outer side of the image-capturing subassembly. The focusing element comprises an actuating element 600 and a lens 700, and the lens 700 is in the actuating element 600. Moreover, in some embodiments, the distance between the lower edge of the lens 700 and the upper surface of the image-capturing element 100 is in a range between 0.4 millimeters and 0.7 millimeters. In some embodiments, the distance between the lower edge of the lens 700 and the upper surface of the image-capturing element 100 may be for example, 0.4 millimeters, 0.45 millimeters, 0.5 millimeters, 0.55 millimeters, 0.6 millimeters, 0.65 millimeters, or 0.7 millimeters.

Moreover, it is understood that, the steps S140 and S150 may be executed in order or at the same time. In other words, in some embodiments, the step S150 may be executed before the step S140; alternatively, in some other embodiments, the step S140 and the step S150 may be executed at the same time.

In some embodiments, on the production line, the image-capturing subassembly can be washed by solutions to ensure no particle retained on the subassembly. In some embodiments, the image-capturing subassembly may be electrically connected to the circuit board 400 through wires. For example, the wire may be gold wire, copper wire, or other metal wires. In some embodiments, in the case that the supporting member 500a is manufactured by adhesive glue layers, the time for material exchange and the time for making other components can be saved, and the adhesive layer 300 as well as the supporting member 500a can be manufactured through the same apparatus. In some embodiments, the adhesive layer 300 and the supporting member 500a are manufactured in the same manufacturing process, so that the overall manufacturing time for the image-capturing assembly 1 can be reduced.

Moreover, in some other embodiments, the manufacturing method of the image-capturing assembly 1 comprises providing an optical sheet 200, forming a plurality of pre-cured layers on the lower surface of the optical sheet 200 corresponding to the non-active area of the image-capturing element 100, and disposing the image-capturing element 100 on the pre-cured layers. In other words, after the position for disposing the pre-cured layers is ensured, either forming the pre-cured layers on the non-active area of the image-capturing element 100 in advance or forming the pre-cured layers on the optical sheet 200 in advance, the optical sheet 200 and the image-capturing element 100 can be disposed correspondingly through the pre-cured layers.

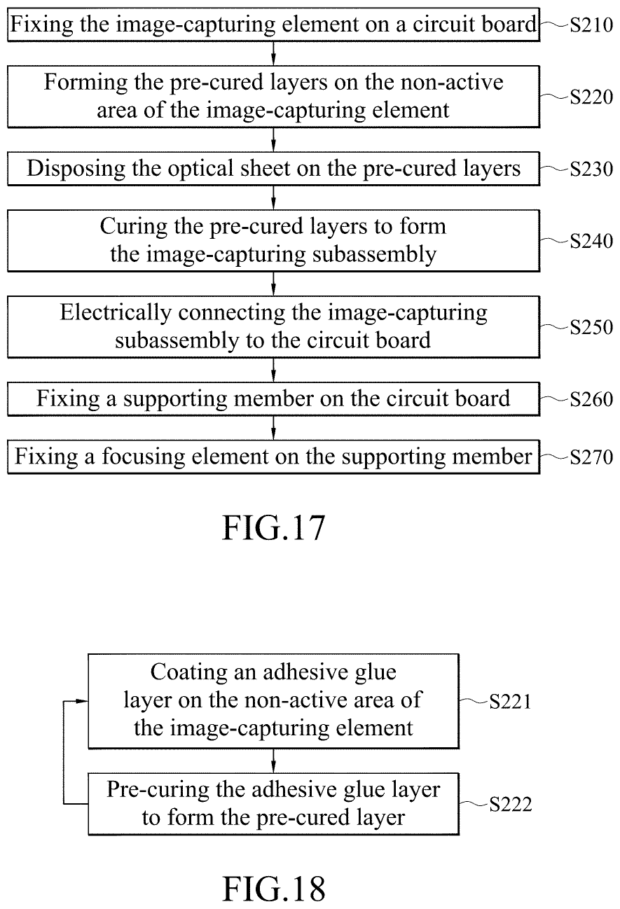

Please refer to FIG. 17, in some embodiments, before the step of forming the pre-cured layers on the non-active area of the image-capturing element 100, the manufacturing method further comprises fixing the image-capturing element 100 on a circuit board 400. In other words, in some embodiments, the manufacturing method of the image-capturing assembly 1 first comprises fixing the image-capturing element 100 on a circuit board 400 (namely, the step S210). Next, the pre-cured layers are formed on the non-active area of the image-capturing element 100 (namely, the step S220). In this embodiment, three pre-cured layers are formed on the non-active area of the image-capturing element 100. Please refer to FIG. 18, in an exemplary example of the step S220, the step of forming each of the pre-cured layers comprises coating an adhesive glue layer on the non-active area of the image-capturing element 100 (namely, the step S221), and pre-curing the adhesive glue layer to form the pre-cured layer (namely, the step S222). After the step S220, the optical sheet 200 is disposed on the pre-cured layers (namely, the step S230). Moreover, the pre-cured layers are cured to form the image-capturing subassembly (namely, the step S240).

In some embodiments, after the step of curing the pre-cured layers to form the image-capturing subassembly (namely, the step S240), the manufacturing method further comprises electrically connecting the image-capturing subassembly to the circuit board 400 (namely, the step S250), fixing a supporting member 500 on the circuit board 400 (namely, the step S260), and fixing a focusing element on the supporting member 500 (namely, the step S270). The supporting member 500 is at an outer side of the image-capturing subassembly. The focusing element comprises an actuating element 600 and a lens 700, and the lens 700 is in the actuating element 600. Moreover, it is understood that, the steps S250 and S260 may be executed in order or at the same time. In other words, in some embodiments, the step S260 may be executed before the step S250; alternatively, in some other embodiments, the step S250 and the step S260 may be executed at the same time.

In some embodiments, the image-capturing element 100 may be detached from a wafer for manufacturing the image-capturing subassembly. Alternatively, in some other embodiments, the image-capturing subassembly can be manufactured using the image-capturing element 100 on the wafer.

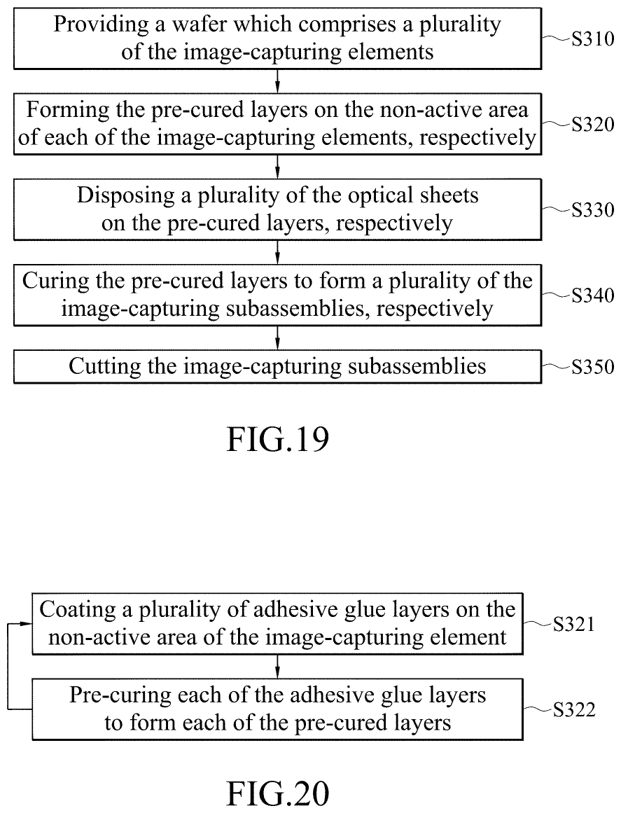

Please refer to FIG. 19. In some embodiments, the manufacturing method of the image-capturing assembly 1 comprises step (1): forming a plurality of pre-cured layers on a non-active area of an image-capturing element 1100. In the step (1), firstly, a wafer is provided, and the wafer comprises a plurality of the image-capturing elements 100 (namely, the step S310). In other words, the image-capturing elements 100 are on the wafer, and the wafer comprises a plurality of the image-capturing elements 100. In some embodiments, before the wafer is provided, a wafer clean procedure can be executed to prevent dust particles from adhering on the active areas 110 of the image-capturing elements 100. Moreover, the step of forming the pre-cured layers on the non-active area of the image-capturing element 100 is forming the pre-cured layers on the non-active area of each of the image-capturing elements 100, respectively (namely, the step S320). In this embodiment, three pre-cured layers are formed on the non-active area of each of the image-capturing elements 100, respectively. In the step (2), an optical sheet 200 is disposed on the pre-cured layers. Specifically, in this embodiment, the step of disposing the optical sheet 200 on the pre-cured layers is disposing a plurality of the optical sheets 200 on the pre-cured layers, respectively (namely, the step S330). In the step (3), the pre-cured layers are cured to form the image-capturing subassembly. Specifically, in this embodiment, the step of curing the pre-cured layers to form the image-capturing subassembly is curing the pre-cured layers to form a plurality of the image-capturing subassemblies, respectively (namely, the step S340). In the step (4), the image-capturing subassemblies are cut (namely, the step S350).

Please refer to FIG. 20. In an exemplary example of the step S320, the step of forming the pre-cured layers on the non-active area of each of the image-capturing element (namely, the step S320) comprises coating a plurality of adhesive glue layers on the non-active area of the image-capturing element 100 (namely, the step S321) and pre-curing each of the adhesive glue layers to form each of the pre-cured layers (namely, the step S322).

Moreover, according to some embodiments of the instant disclosure, by manufacturing the image-capturing subassemblies on the wafer, the units per hour and production efficiency of the image-capturing assembly 1 on the production line can be effectively enhanced.

Based on the manufacturing method mentioned above, the optical sheet 200 is disposed above the image-capturing element 100 through the adhesive layer 300 with a certain height-to-width ratio (H/W). Since the optical sheet 200 and the image-capturing element 100 can be properly bonded with each other through the adhesive layer 300, the image-capturing subassembly has a better mechanical strength. Hence, after the image-capturing subassembly is disposed on the circuit board 400, when the image-capturing subassembly is impacted by an external force, the optical sheet 200 does not detach off easily and the image-capturing subassembly does not break easily. Moreover, it is understood that, in the solution known to the inventor, the optical sheet is placed above the molding member at the outer side of the image-capturing element; conversely, according to one or some embodiments of the instant disclosure, the optical sheet 200 is placed above the image-capturing element 100 through the adhesive layer 300. Therefore, the problems occurring to the solution known to the inventor, that is, the optical sheet may be separated from the molding member, may be broken, or may fall off the molding member when the molding member is affected by an external force (e.g., impacted by the external force), can be prevented.

As above, based on the image-capturing assembly 1 according to one or some embodiments of the instant disclosure, by coating the adhesive layer 300 with a certain height-to-width ratio (H/W) on the non-active area of the image-capturing element 100 and by disposing the optical sheet 200 above the image-capturing element 100, the image-capturing assembly 1 has a shorter back focal length (BFL), thereby reducing the total height TH of the image-capturing assembly 1. Moreover, based on the manufacturing method for image-capturing assembly according to one or some embodiments of the instant disclosure, by inkjet coating and/or by manufacturing several image-capturing subassemblies on the wafer in a one-time process, the production efficiency and the units per hours of the image-capturing assembly 1 can be effectively enhanced.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An image-capturing assembly, comprising:
an image-capturing element having an active area and a non-active area, wherein the non-active area surrounds the active area;
an adhesive layer comprising a plurality of adhesive sublayers, wherein the adhesive sublayers are stacked sequentially, the adhesive layer is on the non-active area of the image-capturing element; and
an optical sheet on the adhesive layer.

2. The image-capturing assembly according to claim 1, wherein a number of the adhesive sublayers is at least three.

3. The image-capturing assembly according to claim 1, wherein an interface is between adjacent two adhesive sublayers of the adhesive sublayers.

4. The image-capturing assembly according to claim 1, wherein a height-to-width ratio (H/W) of the adhesive layer is not less than 0.5 and not greater than 3.

5. The image-capturing assembly according to claim 1, wherein a height of the adhesive layer is in a range between 50 micrometers and 200 micrometers, and a width of the adhesive layer is in a range between 70 micrometers and 200 micrometers.

6. The image-capturing assembly according to claim 1, wherein the adhesive layer is coated on the non-active area through inkjet.

7. The image-capturing assembly according to claim 1, wherein the adhesive layer is a continuous annular section, and a closed space is formed between the image-capturing element, the adhesive layer, and the optical sheet.

8. The image-capturing assembly according to claim 1, wherein the adhesive layer comprises a plurality of adhesive sections, the adhesive sections surround the active area.

9. The image-capturing assembly according to claim 1, further comprising:
a circuit board, below the image-capturing element;
a supporting member at an outer side of the image-capturing element and on the circuit board; and
a focusing element above the supporting member, wherein the focusing element comprises an actuating element and a lens, and the lens is in the actuating element.

10. The image-capturing assembly according to claim 9, wherein a distance between a lower edge of the lens and an upper surface of the image-capturing element is in a range between 0.4 millimeters and 0.7 millimeters.

11. The image-capturing assembly according to claim 9, wherein the supporting member comprises a plurality of supporting sublayers stacked sequentially.

12. The image-capturing assembly according to claim 11, wherein the supporting member is coated on the circuit board at the outer side of the image-capturing element through inkjet.

13. A manufacturing method for image-capturing assembly, comprising:
forming a plurality of pre-cured layers on a non-active area of an image-capturing element;
disposing an optical sheet on the pre-cured layers; and
curing the pre-cured layers to form an image-capturing subassembly.

14. The manufacturing method according to claim 13, wherein a number of the pre-cured layers is at least three.

15. The manufacturing method according to claim 13, wherein the step of forming each of the pre-cured layers comprises: coating an adhesive glue layer on the non-active area;
and pre-curing the adhesive glue layer to form the pre-cured layer.

16. The manufacturing method according to claim 13, wherein after the step of curing the pre-cured layers to form the image-capturing subassembly, the manufacturing method further comprises: fixing the image-capturing subassembly on a circuit board and electrically connecting the image-capturing subassembly to the circuit board; fixing a supporting member on the circuit board, wherein the supporting member is at an outer side of the image-capturing subassembly; and fixing a focusing element on the supporting member, wherein the focusing element comprises an actuating element and a lens, and the lens is in the actuating element.

17. The manufacturing method according to claim 13, wherein before the step of forming the pre-cured layers on the non-active area of the image-capturing element, the manufacturing method further comprises: fixing the image-capturing element on a circuit board.

18. The manufacturing method according to claim 17, wherein after the step of curing the pre-cured layers to form the image-capturing subassembly, the manufacturing method further comprises: electrically connecting the image-capturing subassembly to the circuit board; fixing a supporting member on the circuit board, wherein the supporting member is at an outer side of the image-capturing subassembly; and fixing a focusing element on the supporting member, wherein the focusing element comprises an actuating element and a lens, and the lens is in the actuating element.

19. The manufacturing method according to claim 13, wherein the image-capturing element is on a wafer, the wafer comprises a plurality of the image-capturing elements; the step of forming the pre-cured layers on the non-active area of the image-capturing element is forming the pre-cured layers on the non-active area of each of the image-capturing elements, respectively; the step of disposing the optical sheet on the pre-cured layers is disposing a plurality of the optical sheets on the pre-cured layers, respectively; and the step of curing the pre-cured layers to form the image-capturing subassembly is curing the pre-cured layers to form a plurality of the image-capturing subassemblies, respectively.

20. The manufacturing method according to claim 13, wherein an interface is between adjacent two pre-cured layers of the pre-cured layers.

21. The manufacturing method according to claim 15, wherein the adhesive glue layer is coated on the non-active area through inkjet.

22. The manufacturing method according to claim 13, wherein a height-to-width ratio (H/W) of the pre-cured layers is not less than 0.5 and not greater than 3.

23. The manufacturing method according to claim 13, wherein a height of the pre-cured layers is in a range between 50 micrometers and 200 micrometers, and a width of the pre-cured layers is in a range between 70 micrometers and 200 micrometers.

24. The manufacturing method according to claim 16, wherein a distance between a lower edge of the lens and an upper surface of the image-capturing element is in a range between 0.4 millimeters and 0.7 millimeters.

25. The manufacturing method according to claim 18, wherein a distance between a lower edge of the lens and an upper surface of the image-capturing element is in a range between 0.4 millimeters and 0.7 millimeters.
